(19) United States
(12) Patent Application Publication
(10) Pub. No.: US 2019/0219724 A1
(43) Pub. Date: Jul. 18, 2019

(54) Wellbore Integrity Mapping Using Well-Casing Electrodes and Surface-Based Electromagnetic Fields

(71) Applicant: GroundMetrics, Inc., San Diego, CA (US)

(72) Inventors: Michael WILT, Walnut Creek, CA (US); Greg NIEUWENHUIS, Lethbridge (CA)

(73) Assignee: GroundMetrics, Inc., San Diego, CA (US)

(21) Appl. No.: 16/337,010

(22) PCT Filed: Oct. 12, 2017
(86) PCT No.: PCT/US2017/056324

§ 371 Date: Mar. 27, 2019

Related U.S. Application Data
(60) Provisional application No. 62/407,738, filed on Oct. 13, 2016.

(51) Int. Cl. G01V 3/30; E21B 47/12; G01V 1/16; G01V 1/46; G01V 3/10; G01V 1/52

(52) U.S. Cl. CPC G01V 3/30; E21B 47/122; G01V 1/52; G01V 1/46; G01V 3/10; G01V 1/16

(57) ABSTRACT

The integrity of a well is evaluated using a non-invasive and lower cost screening system and method. The system and method identify whether well integrity has degraded and whether there is a clear break in the casing of a well, a corroded patch or faults in the casing. This is accomplished without requiring entry into the well.

### CROSS-REFERENCE TO RELATED APPLICATIONS

This application claims the benefit of U.S. Provisional Application No. 62/407,738, which was filed on Oct. 13, 2016 and titled “Wellbore Integrity Mapping Using Well-Casing Electrodes and Surface Based Electromagnetic Fields”. The entire content of this application is incorporated herein by reference.

### FIELD OF THE INVENTION

The present invention generally relates to a non-invasive and low-cost screening method and system for evaluating the integrity of a well completion using electromagnetic measurements.

### BACKGROUND OF THE INVENTION

Among the most serious issues facing the oil and gas industry is the condition of older wells. That is, once a well has been in use for some time, the casing and cement are subject to chemical aging and corrosion, and this weakens the well. In addition, if a well is used for production, near-well saturation changes can result in local ground compaction, and the well can become mechanically unstable. There are millions of existing oil and gas wells in this condition in the United States, many of them plugged and abandoned. These conditions can pose significant environmental issues. Injector wells, such as wastewater injectors, are also subject to environmental or chemical degradation, especially as the geology and geological structure can be altered due to the addition of new fluids, larger fluid volumes and/or increased pressure or flow of fluids. Wells drilled for purposes outside the oil and gas industry, including wells drilled for exploration, assessment or other production purposes, are also in need of casing integrity evaluation, such as geothermal wells drilled into highly corrosive environments, or potentially environmental monitoring wells in the same.

Existing technology for casing integrity evaluation includes an array of logging services provided by Schlumberger®, Baker-Hughes® and others in the well services field. These consist of seismic and electromagnetic logging tools to evaluate the casing and cement integrity of wells, and they are very effective. However, these methods are time consuming and expensive, as they require extensive setup and measurement time (seismic) or for instrumentation to be invasively lowered down the well casing (temperature and electromagnetic). Due to these factors, field operators use these logging services primarily on wells that exhibit an obvious issue, e.g., surface leakage or suspected downhole leakage. These services are not run on the vast majority of older wells or before wells have been plugged and abandoned.

A steel well casing has offered an attractive means to access a deep formation from the surface. Energy can be readily coupled into the formation with a simple grounded electrode, and some of this energy will flow to the full well depth and leak into the formation along the path. Well casing antennas have been considered for a number of years in geophysical applications. Numerical models considering well casings have been described in papers by Kong et al. (Kong, F. N., Roth, N. F., Olsen, P. A., and Stalheim, S. O., 2009, “Casing Effects in the sea-to-borehole Electromagnetic Methods”, Geophysics 74, No. 5) and Pardo et al. (Pardo, D., Torres-Verdin, and Demowicz, D., 2007, “Feasibility study for 2D frequency-dependent electromagnetic sensing through casing”, Geophysics 72, No. 5). Field applications have included electrical imaging (Newmark et al. (Newmark, R. N., Daily, W. D., and Ramirez, A., 1999, “Electrical Resistance Tomography Using Steel Cased Boreholes as Electrodes”, Society of Exploration Geophysicists Annual Meeting) and Rucker et al. (Rucker, D. F., Loke Meng, T., Marc T. Levitt and Noonan, G., 2007, “Electrical-resistivity characterization of an industrial site using long electrodes”, Geophysics 75, No. 4), logging (Schenkel, C. J., 1991, “The electrical resistivity method in cased bore-holes”, Ph.D. Thesis, University of California, Berkeley, hereinafter “Schenkel”) and telemetry (Schenkel). Much of the theoretical work stems from studies by Wait (Wait, J. R., 1995, “Analytical solution of the bore-hole resistivity casing problem”, Geophysics 60, No. 4) and Kaufman (Kaufman, A. A., 1990, “The electrical field in a borehole with a casing”, Geophysics 55, No. 1). In addition, a series of logging tools for formation evaluation through steel casing have been developed independently by Vail (U.S. Pat. No. 4,820,989) and Kaufman (U.S. Pat. No. 4,796,186). A good explanation of the physics of this technique is provided in Schenkel. In addition, U.S. patent application Ser. No. 14/426,601 describes a system and method that enable a borehole casing to be used to establish electromagnetic fields within the earth. The entire content of these documents is incorporated herein by reference.

### SUMMARY OF THE INVENTION

The embodiments of the present invention described herein include a system for evaluating well casing integrity using electromagnetic measurements. The system includes an electromagnetic source configured to produce a current flow in a well casing located in a borehole. The system also includes at least one sensor external to the borehole configured to measure an electric potential or magnetic field in the earth to create sensor data. A controller is configured to: 1) determine at least one component of an electromagnetic field emanating from the well casing based on the sensor data; 2) determine at least one electromagnetic property of the well casing based on the at least one component of the electromagnetic field; and 3) determine the integrity of the well casing based on the at least one electromagnetic property of the well casing. The at least one electromagnetic property of the well casing can comprise an electrical conductivity and/or magnetic permeability of the well casing. Preferably, the at least one component of the electromagnetic field, the at least one electromagnetic property of the well casing and the integrity of the well casing are determined without using data from a sensor located in the borehole.

Determining the integrity of the well casing includes, but is not limited to, determining if the well casing is corroded or broken, severed or otherwise parted using the at least one electromagnetic property of the well casing. Determining the integrity of the well casing can further include determining an effective depth or severity of a corrosion or break using the at least one electromagnetic property of the well casing. Determining the integrity of the well casing also includes determining if the well casing requires further evaluation or remediation using the at least one electromagnetic property of the well casing.

Preferably, the at least one sensor is capacitively coupled to the earth and measures the electric potential of the earth, and the at least one sensor is configured to measure the electrical potential of the earth at a frequency below 1 kHz. Alternatively, the at least one sensor is magnetically coupled to the earth and measures the magnetic field of the earth. Preferably, the at least one sensor is configured to measure the magnetic field of the earth at a frequency below 1 kHz. The system preferably includes at least one capacitively-coupled sensor and/or at least one magnetically-coupled sensor.

In one embodiment, the at least one sensor is located on the surface of the earth. In another embodiment, the at least one sensor is located beneath the surface of the earth, preferably at a depth of less than 5 meters. The at least one sensor is placed at an arbitrary location with respect to the well casing. In yet another embodiment, the at least one sensor is located more than 100 meters from a wellhead of the well casing. In one embodiment, the sensors are placed at the intended locations manually. In other embodiments, sensors are placed using automated means, including but not limited to a self-propelled means of mobility, an unmanned aerial vehicle, an unmanned ground vehicle, a remotely controlled or piloted vehicle, an autonomous vehicle or the like. In a preferred embodiment, the at least one sensor is placed along a line extending radially from the well casing. The at least one sensor measures at least one component of the electromagnetic field in the earth, including the intrinsic field of the earth formation, the field emanating from other electromagnetic sources at the measurement location and the field emanating from the well casing. The components of the electromagnetic field include the vertical and horizontal components of the electric field and magnetic fields, and a combination thereof.

The electromagnetic source can be configured to apply electrical current through an electrical connection to the well casing at a drive point and a return connection at a ground point, connected to the earth. An electrical signal is applied between the drive point and ground point, producing an electrical current in the well casing with a longitudinal component. The drive point can be connected to the well casing at, above or below the surface of the earth or connected to the earth near the well casing. In other embodiments, the electromagnetic source induces an electrical current in the well casing with a longitudinal component by inductively coupling to the well casing. This is done by employing at least one loop of wire encircling the well casing, by placing coils of wire placed near the well casing, by placing a coil of wire inside the borehole, or the like. When current is passed through the loop of wire or coils, together with the well casing, they effectively act as a transformer, inducing a current in the well casing.

The electromagnetic source is preferably configured so that the current flow produced in the well casing contains a sinusoidal, square, arbitrary or transient waveform, or combination thereof. The frequency of the current flow produced in the well casing spans a range between 0 Hz and 1 GHz and, in the preferred embodiment, spans a range between 0.05 Hz and 1 kHz.

The at least one sensor measures the amplitude or phase of the electric potential or magnetic field, or a combination thereof. Preferably, at least two measurements of the electric potential are combined to derive the electric field. The sensor data is processed to improve signal quality by arithmetic averaging, filtering, calculating the coherence across multiple applied and measured signals, using a lock-in technique or the like.

The sensor data is fit to a model comprising the electromagnetic responses of the background formation and the well casing. This model can take into account theoretical data ascribed to the background formation and the well casing or empirical data collected previously by any method, or a combination thereof. The model can constitute a one-, two-, three- or four-dimensional representation of the well casing (or some combination thereof) and the background formation in which the well casing is located. Ultimately, the model is used to derive the well casing's electrical conductivity, magnetic permeability, electrical current profile, or electromagnetic field profile, or a combination thereof.

The embodiments of the invention also include a method for evaluating well casing integrity using electromagnetic measurements by: producing a current flow in a well casing using an electromagnetic source, wherein the well casing is located in a borehole; measuring an electric potential or magnetic field of the earth using at least one sensor external to the borehole to create sensor data; determining at least one component of an electromagnetic field emanating from the well casing using the sensor data; determining at least one electromagnetic property of the well casing using the at least one component of the electromagnetic field; and determining the integrity of the well casing using the at least one electromagnetic property of the well casing.

The invention provides an alternative, non-invasive and lower cost screening method for evaluating the integrity of a well, either during construction, upon completion, or after a period of use. Wells under construction can be monitored using this method to evaluate integrity of the well casing or parts thereof, monitor construction progress, or the like. A common characteristic of the completed wells at issue is that the casing is corroded or discontinuous, usually at depth intervals associated with the fluid entries or mechanical failures. The well casing may be partially or fully corroded or broken in single or multiple intervals, so the path of any induced or injected electrical current and external electrical field will be fundamentally and significantly altered by this condition. Therefore, one means to detect integrity issues and to map the depth to corroded intervals is with electrical methods, including but not limited to electrical or magnetic or electromagnetic sources on the casing and surface-based electrical field or magnetic field or electromagnetic measurements. The method of the present invention identifies whether well integrity has degraded, the associated depth interval or intervals associated with that degradation, and also whether there is a clear break in the casing or simply corrosion induced degradation. This does not, in principle, replace the existing casing logging technology but can serve as a screening tool to identify “problem” wells. This would allow a larger number of wells to be screened that would otherwise go unevaluated, and then the problem wells can be logged for further evaluation as appropriate.

One embodiment of the proposed method uses the concept of the continuity of electrical current down a well casing, and the subsequent generation of an electromagnetic field, to establish if the casing is discontinuous, degraded or intact. By placing a current source on the wellhead, or otherwise electrically connecting to the well, and measuring the electromagnetic field on the surface along a profile or line extending from the well, the depth of the upper intact section and its electrical properties (e.g., electrical conductivity and wall thickness) can be established. By knowing the completion details, it can be determined if a well casing has degraded or is intact. Importantly, instruments needed to both drive the electrical current and measure the electromagnetic field may be located at the surface, enabling rapid setup and measurement and lowering the cost of the procedure with respect to traditional invasive logging.

The current focus is on oil and gas wells, but the invention is applicable to any situation where well casing integrity is important, including but not limited to geothermal, groundwater or underground water storage, carbon dioxide capture and storage, wastewater storage and gas storage, mineral or ore exploration, assessment and production. The invention can be used onshore as well as offshore.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a schematic diagram of a casing and field setup;

FIG. 2 is a theoretical depiction of a DC current down a well casing placed in an ideal and homogenous formation;

FIG. 3 is a theoretical model of the current down well casings with different completion depths;

FIG. 4 shows electrical field profiles from vertical well casings of various depths;

FIG. 5 shows electrical field profile ratios for various lengths of casing from FIG. 4;

FIG. 6 shows electrical field profiles for a 2000-m casing, a 300-m casing and a 2000-m casing broken at 300 m;

FIG. 7 shows the electrical field ratio between the 300-m casing and the 2000-m casing broken at 300 m;

FIG. 8 shows electrical field profiles of fully and partially corroded casings compared to an unbroken 2000 m casing; and

FIG. 9 shows electrical field ratios of the fully and partially corroded casings compared to the unbroken 2000 m casing.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting but merely as a representative basis for teaching one skilled in the art to employ the present invention.

The present invention is directed to a system and method for probing the electrical properties of a well casing by measuring the electromagnetic field emanating from the well casing. The well casing can be of any type including, but not limited to, vertical, horizontal, deviated or the like. In addition, as used herein, the term “well casing” should be understood to also encompass production tubing placed in a borehole. The well casing is connected to an electromagnetic source that produces a current flow. The measured component of the electromagnetic field is fit to a model that represents the electromagnetic properties of the well casing and the background formation. This model is used to determine if the casing is corroded or broken, estimate the effective depth or severity of the break and, finally, determine if the well casing requires further evaluation or remediation.

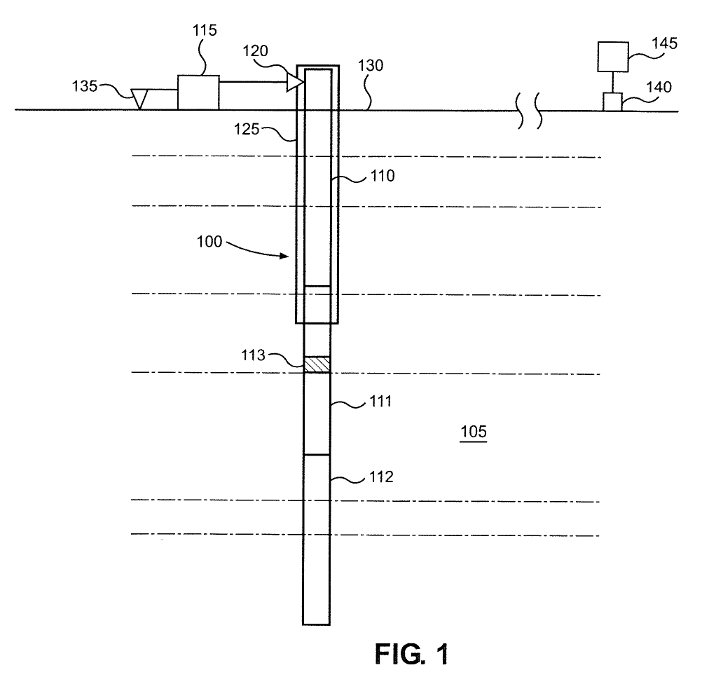

A segmented casing 100 in an arbitrary formation 105 is shown in FIG. 1. Segmented casing 100 is described by the properties of individual pipes 110-112 and casing joints extending throughout the length of the pipe. The well casing material generally has metallic properties and can be steel, steel alloy, brass, copper or the like. Pipe 111 is shown as having a corroded patch 113. An electromagnetic source 115 is in electrical contact with well casing 100. Electromagnetic source 115 comprises a drive point 120 located on a surface casing 125 at or near the earth's surface 130. A ground point 135 is located at or near well casing 100 or at a distant location. In the preferred embodiment, drive point 120 is connected to well casing 100 at the wellhead. Source 115 preferably supplies an electrical current, or alternatively an electrical voltage, onto drive point 120 with respect to ground point 135.

While drive point 120 is placed on or near the wellhead, ground point 135, or the point where the current returns to electric source 115, can be placed at any location with respect to the wellhead. At DC or very low frequencies, the fields are most sensitive to the current in well casing 100, the current leaking from casing 100 and the current at ground point 135. At higher frequencies, however, electric source 115 itself and the electrical wires connecting it to the drive and ground points 120, 135 have an associated field, which may not be desirable.

The distance between the wellhead and ground point 135 is preferably 1 km and can be less than 10 m, less than 50 m, less than 100 m, less than 500 m, less than 1 km, less than 1.5 km, less than 2 km, less than 3 km, less than 5 km, less than 10 km or less than 15 km. In the preferred embodiment, ground point 135 is located at or near the wellhead. This is the most convenient grounding location from a data collection perspective. In some cases, however, especially for complex near-well completions, this can lead to a complex current pattern, and ground point 135 could instead be placed at a distant point.

In another embodiment, electromagnetic source 115 induces an electrical current in well casing 100 with a longitudinal component by inductively coupling to well casing 100. This is done by employing at least one loop of wire encircling well casing 100 or coils of wire placed near well casing 100, or the like. When current is passed through the loop of wire or coils, together with well casing 100, they effectively act as a transformer, inducing a current in well casing 100. This inductive source method generally has the benefit of not requiring electrical coupling to well casing 100 but can, in practice, be more expensive or time consuming to set up depending on the wellhead configuration.

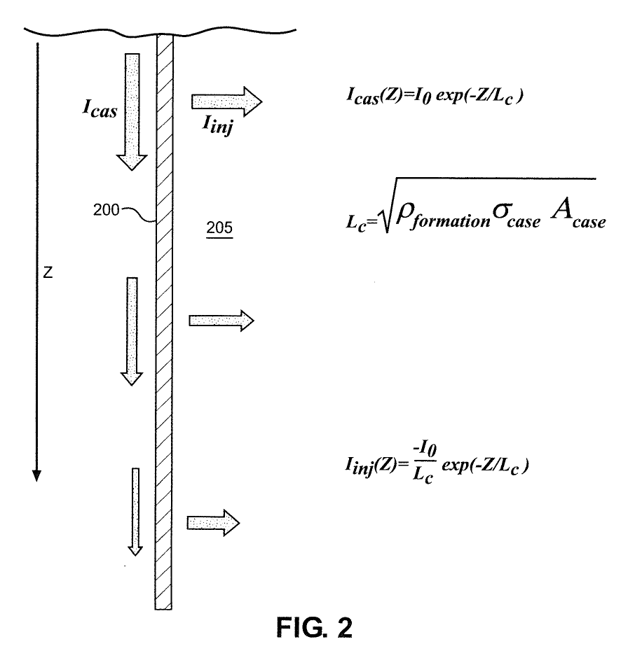

The effect of electromagnetic source 115 in contact with well casing 100 is to produce a current flow in well casing 100 having a longitudinal component, defined as along the direction of the borehole. The current flows along well casing 100 and also into the surrounding background formation 105 of earth. The flow of current in this configuration has been considered theoretically in Schenkel for DC currents and, more recently, by Cuevas (Cuevas N., 2013, “On the EM fields due to dipolar source inside infinite casing”, Geophysics 73, No. 4, incorporated herein by reference) for AC currents. In those treatments, the current is divided into currents flowing along the pipe and currents penetrating the ideal and homogenous formation adjacent to the well (FIG. 1). As shown in FIG. 2, the current down a casing 200 depends on the properties of casing 200, as well as the properties of a formation 205.

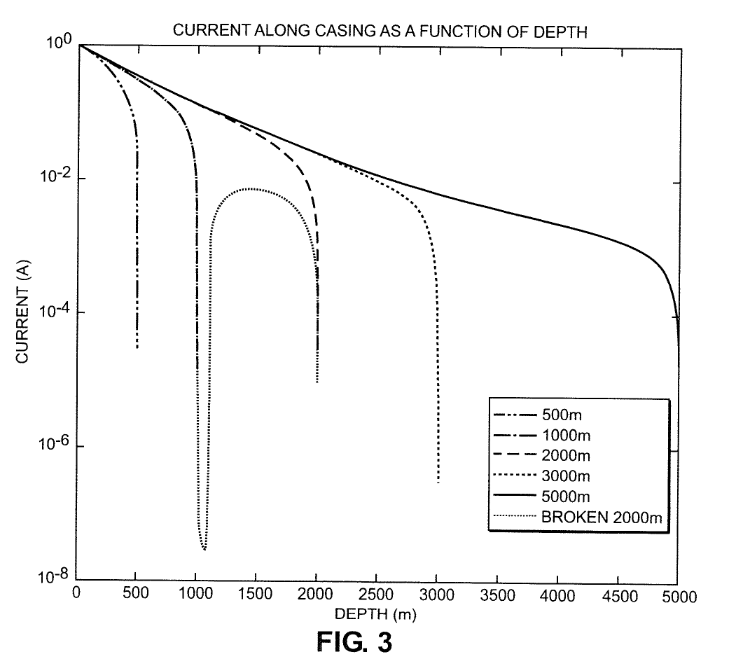

For a finite length casing, the currents are related to the casing length as well as its properties and the formation. FIG. 3 shows the current down several casing lengths, with identical pipe properties in a 10 ohm-m halfspace. FIG. 3 illustrates that: 1) the current is a strong function of the casing length, and it is discontinuous at the bottom of the casing; and 2) the current for a broken casing is almost identical to that of a casing with the same length as the upper segment.

For a vertical well, the electromagnetic field associated with these currents is, in general, a cylindrically symmetric field comprising radial and vertical electrical field components and a tangential magnetic field. The nature of this electromagnetic field depends on the casing properties, the casing length and the background formation resistivity, and this can be used to infer the distributions of all these quantities.

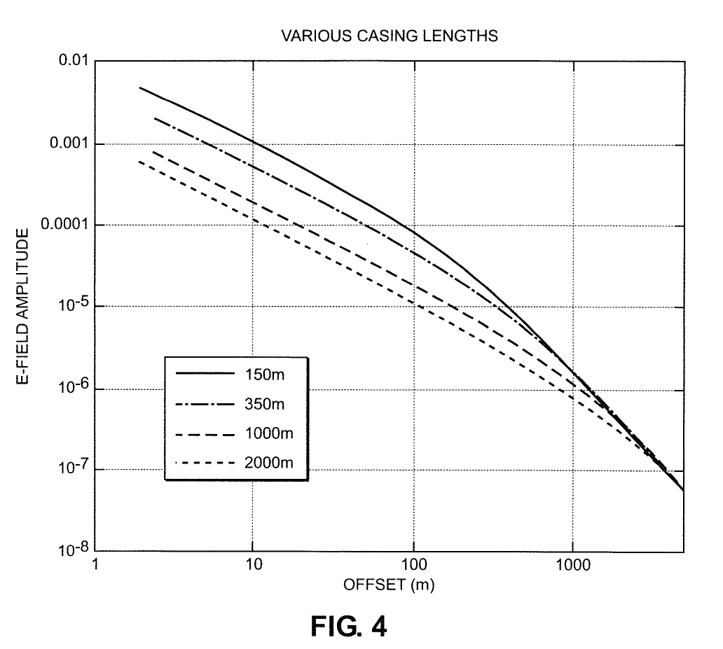

This is illustrated in FIG. 4, wherein a current is applied to the top of several well casings of various depths in a 10 ohm-m homogeneous halfspace, with the return current electrode far away, effectively at infinity. The radial magnetic field can then be plotted in a profile emanating from the wellhead, with calculations being made using commercial electromagnetic modeling code.

As can be seen, the fields decay roughly exponentially with distance, showing a linear slope on the log-log plot. Secondly, there is a large difference in the field for the various casing lengths. The largest fields are associated with the shortest casings, which is reasonable because the current is concentrated closer to the surface in these cases. Finally, the difference between the plots is mostly manifest in the first 1000 m from the wellhead. This last point is very significant because it allows discriminating between deep casing strings and measurements fairly close to the wellhead.

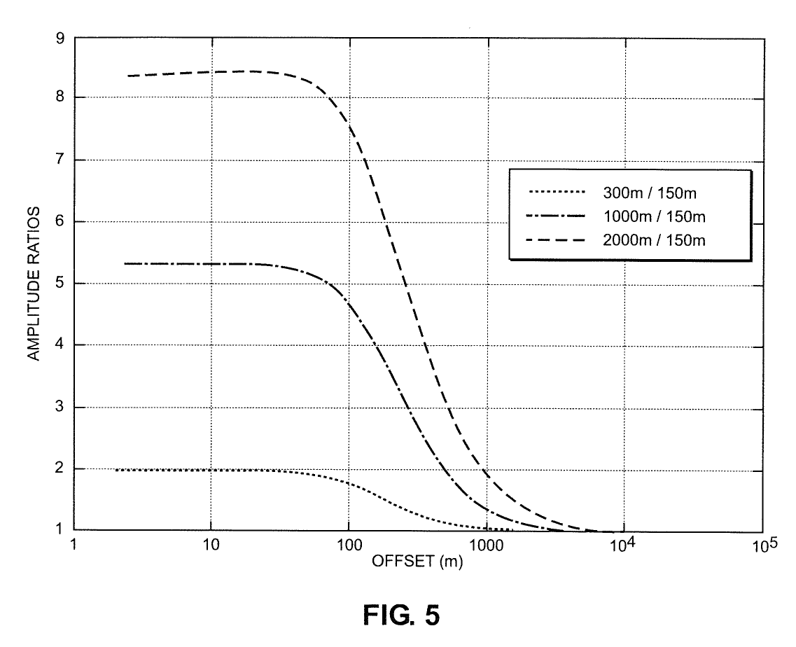

The large differences between the responses can be quantified by taking the ratio of the curves. This is represented in FIG. 5. Here there is shown an almost order of magnitude change between the shallowest and deepest casings. In addition, it should be noted that the effect is almost static within 100 m from the wellhead but gradually diminishes with distance.

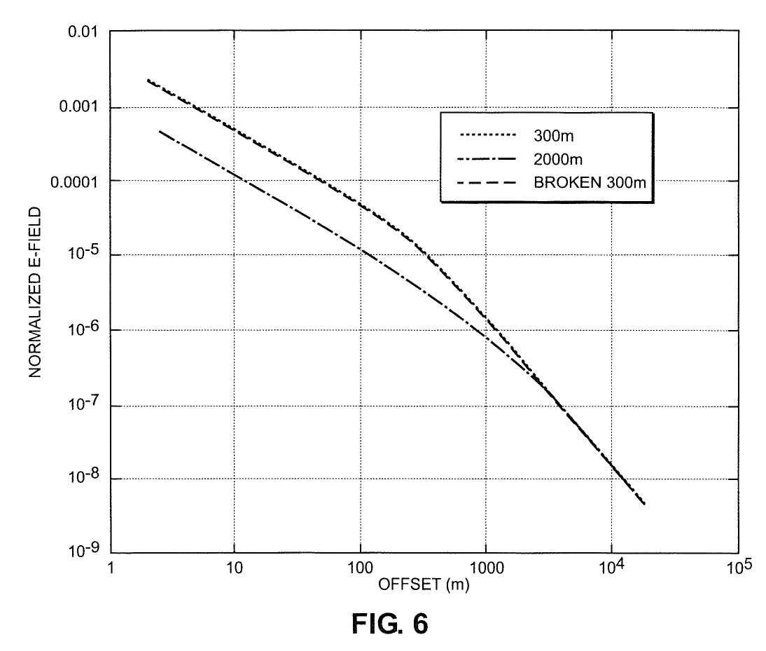

The field patterns from ruptured and corroded casings as compared to unbroken pipes of the same length are described below. Beginning with a simple model, fields from a simple 1-m rupture of a 2000-m well casing at a depth of 300 m are observed. The profiles for two intact casings of 300 m and 2000 m in FIG. 6 are compared. Note that the profile for the 2000-m casing broken at 300 m almost exactly matches the 300-m casing profile.

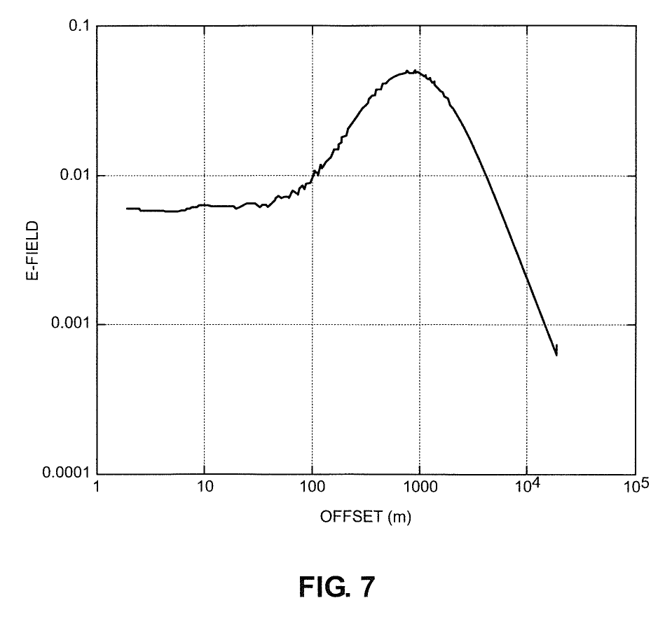

When the broken casing profile is subtracted from the intact 300-m casing profile, as can be seen in FIG. 7, the difference is a few percent, with a maximum difference of about 5%, at an offset of 800 m. This means that little of the current flowing into the casing can “jump the gap” to the segment below, and it suggests that sensing the condition of the casing below a full rupture may not be possible with the electromagnetic system and method disclosed herein.

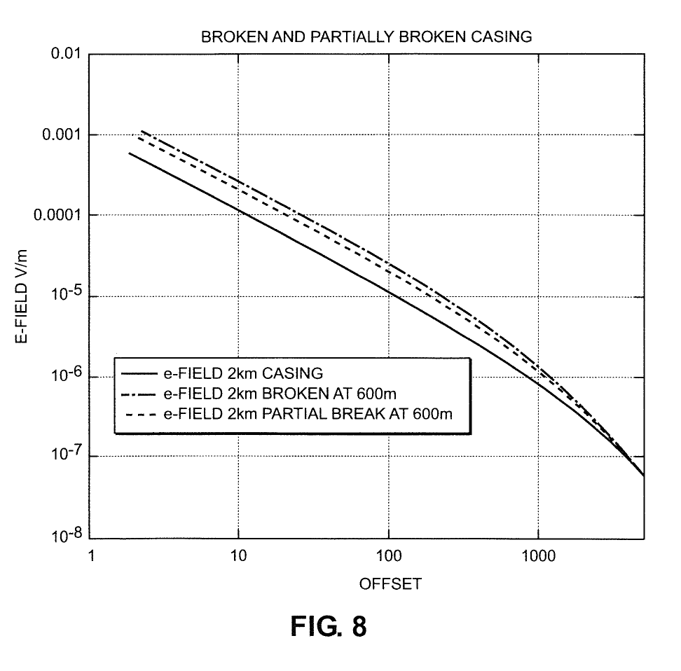

Next, a corroded casing for which the conductivity within the casing has been reduced from 5.5×10⁶ to 5.5×10² over a 3-m zone, for example due to chemical weathering is considered. In FIG. 8, the results are plotted with those for an intact casing and then one with a clean break at 600 m. The corroded casing is easily distinguishable by observation from the intact casing, being closer in response to the broken pipe. The offset between these two curves is a function the amount of corrosion in the affected segment of pipe.

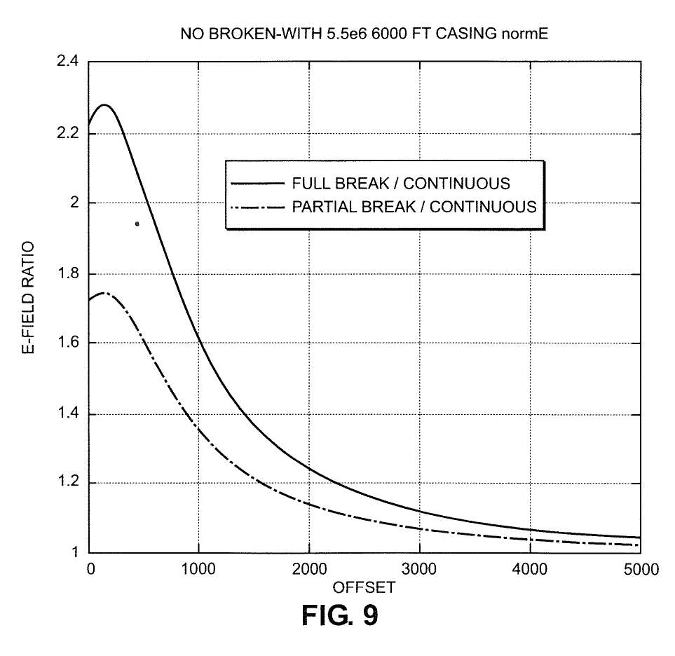

Taking the field ratios and plotting them versus offset in FIG. 9, the partially broken casing appears very similar to the broken casing but with a smaller offset. This means that it is possible to quantify the level of corrosion from these profiles. This also suggests that, with a corroded casing, it is possible to map other casing irregularities below the upper patch because some current is still flowing within the pipe. This contrasts with a rupture where only the upper break is seen.

The system and method disclosed herein employ at least one sensor placed external to the borehole. For example, FIG. 1 shows a sensor 140. The ability to perform measurements external to the borehole is a novel component of this system and method, which greatly reduces the time and cost of performing the procedure with respect to conventional logging type methods that rely on sensor electrodes placed inside the borehole itself. The distance between the sensors and the wellhead is more than 10 m, 100 m, 300 m, 500 m or 1 km.

The sensors can be placed on the surface of the earth, meaning placed at the level of the earth's surface without significantly modifying the level. The sensors can also be placed beneath the surface of the earth by burying them below the level of the earth's surface. The depth of the buried sensors is less than 0.1 m, 0.3 m, 0.5 m, 1 m or 5 m. In the preferred embodiment, the sensors are placed on the surface of the earth, and provisions are made to facilitate practical data collection, including but not limited to securing the sensors to the ground, covering the sensors with weather-proof fixture or material, marking the location of the sensors using visible tags, connecting data and or power cables to the sensors and connecting to the sensors external devices such as data acquisition systems, computers, transmitters, antennas or the like. For example, a controller 145 is shown connected to sensor 140 in FIG. 1. The sensors can be placed at the intended locations manually or using automated means, including but not limited to a self-propelled means of mobility, an unmanned aerial vehicle, an unmanned ground vehicle, a remotely controlled or piloted vehicle, an autonomous vehicle or the like. After the measurement is complete, recovery of the sensors can proceed either by manual or automated means. Additionally, the sensors can be left in place for the purpose of performing future measurements or abandoned.

In the preferred embodiment, multiple sensors are used to perform the measurement. The placement of the sensors will, in general, vary according to the local environment, ground topology, well casing topology, casing geometry, local infrastructure, obstacles and the like. The sensors can be placed in an arbitrary configuration with respect to the wellhead, including but not limited to a linear array of sensors that stretches radially from the wellhead to a distance of several kilometers. In the preferred embodiment, sensors are spaced logarithmically with a short spacing near the wellhead and progressively longer spacings at greater distances. In the preferred embodiment, approximately twenty measurement points are used.

The at least one sensor is used to measure at least one component of the electromagnetic field. In the system and method described herein, the electromagnetic field includes the intrinsic field of the earth formation, the field emanating from other electromagnetic sources at the measurement location, and the field emanating from the well casing. The components of the electromagnetic field include the electric and magnetic fields, and a combination thereof. In one embodiment, the magnitude and direction of the electric field are calculated by measuring the electric potential at two points in space separated by a distance, subtracting one electric potential from the other, and dividing by the distance. The two electric potentials can be measured using one appropriately configured sensor or two distinct sensors. The components generally include any orthogonal decompositions of the field including components vertical and horizontal with respect to the direction of the earth's gravity at the measurement location.

The system and method disclosed herein rely on measurements of the electric field, the magnetic field or a combination thereof. In practice, components of both the electrical and magnetic fields emanating from a casing are sensitive to the casing properties, but the electrical fields are generally more sensitive to the formation resistivity than the magnetic fields. In addition, the electrical fields typically have a greater sensitivity to formation heterogeneities, such as geological contacts, which distort the field profiles, making it more difficult to interpret the casing properties. Conversely, magnetic fields are usually less sensitive to the formation properties, especially far from the well, being more responsive to longitudinal casing currents. However, these fields are sensitive to the magnetic permeability of the casing, which is substantial in iron pipe and can vary somewhat from pipe to pipe even for intact casing. For most cases, the near well formation resistivity determined from logging adequately describes the resistivity, the pipe properties do not change markedly between casing joints, and electric or magnetic field measurements are effective. For cases in which the formation and casing properties are not well known from completion and logging data, it may be desirable to use both fields for casing evaluation.

In one embodiment, the sensor constitutes a capacitively-coupled electric field sensor. A capacitively-coupled sensor generally operates by having its sensing electrode capacitively coupled with the earth and measuring the earth's electric potential. One such sensor is disclosed in U.S. Pat. No. 9,405,032, which is incorporated herein by reference. In another embodiment, the sensor constitutes a resistively-coupled sensor, which generally operates by having its sensing electrode in direct electrical contact with the earth.

In another embodiment, the sensor constitutes a magnetically-coupled sensor. Such sensors are commonly known as magnetometers and measure the local magnetic field. The sensor can include but is not limited to a magnetic transducer, a single or multiple coil of wire.

In one embodiment, the sensor can also include the ability to amplify the signal and apply filtering or processing techniques to improve the signal and to reduce unwanted noise or interference. These techniques include but are not limited to arithmetic averaging, filtering, calculating the coherence across multiple applied and measured signals from the sensor, using a lock-in technique or the like. In one embodiment, the sensor can also include a data acquisition system to record, process, store, transmit, or a combination thereof, the measured signal.

The electrical current produced in the well casing can be alternating (AC) or constant (DC) and can contain sinusoidal, square, arbitrary or transient waveforms, or a combination thereof. The frequency range of the signal has a lower bound of 0 Hz, 0.05 Hz, 0.1 Hz, 0.5 Hz, 1 Hz, 3 Hz, 5 Hz, 10 Hz, 30 Hz, 50 Hz, 100 Hz, 500 Hz, 1 kHz or 10 kHz. The frequency range of the signal has an upper bound of 1 Hz, 5 Hz, 10 Hz, 30 Hz, 50 Hz, 100 Hz, 1 kHz, 5 kHz, 10 kHz, 50 kHz, 100 kHz, 500 kHz, 1 MHz, 10 MHz, 100 MHz or 1 GHz. In the preferred embodiment, the source supplies an AC current between 0.05 Hz and 1 kHz.

Varying the source frequency can be very useful for casing evaluation because the effect of magnetic permeability in the casing is better determined with AC measurements. In addition, higher frequencies have greater sensitivity to the shallower casing segments, and lower frequencies are more sensitive to the deep parts of the well.

Harmonic waveforms such as sinusoidal, square or arbitrary can be applied. It can also be useful to apply a transient waveform in addition to or instead of a frequency waveform, i.e., one with a significant off-time. Irregularities on the casing can serve to reflect currents traveling down the pipe, and these reflections may best be detected with a transient waveform.

Interpretation of the measured signals relies on fitting the data to a model comprising a background response and a well casing response based on empirical or theoretical data, or a combination thereof. In one embodiment, the collected electromagnetic field profiles are generally fit using computer inversion. The nonlinear inversion assumes a background resistivity model based on the well logs or other known data and uses the well completion data as a starting model. The inversion then adjusts the model by changing the completion conductivity and/or magnetic permeability as a function of depth to fit the data. For vertical wells, this can be a simple one-dimensional code that may fit data in a few minutes or faster. A more extensive three-dimensional code would produce the best results for more complex completions, such as horizontal or deviated wells. Ultimately, the model is used to derive the well casing's electromagnetic properties, including but not limited to the electrical conductivity, magnetic permeability, electrical current profile, or electromagnetic field profile, or a combination thereof.

In one embodiment, the electromagnetic properties of the well casing are used to determine if the casing is corroded or broken. In another embodiment, the electromagnetic properties of the well casing are used to determine the effective depth and/or severity of the corrosion and/or break. In yet another embodiment, the electromagnetic properties of the well casing are used to determine if the casing requires further evaluation.

Based on the above, it should be readily apparent that the present invention enables well casing assessment without requiring that any instrumentation enter the well. The invention enables identification of wells that have degraded, by identifying wells that have developed a clear break, a corroded patch or faults in the well casing. The invention can be used on older and non-producing, non-operational, or non-injecting wells, as well as to verify integrity of new completions. The disclosed system and method allow operators to quickly and efficiently screen wells for potential problems that require more detailed assessment and remediation. While certain preferred embodiments of the present invention have been set forth, it should be understood that various changes or modifications could be made without departing from the spirit of the present invention. For example, the system could include of multiple segments of cable of different lengths, which when attached together will be approximately 500 m long. Each cable could have take-outs spaced along its length at varying distances (ranging from 5 m to 40 m), where either an eQube sensor or a ground reference stake can be attached. The cables can attach to each other, and to a data acquisition unit (DAQ). The DAQ is preferably placed at roughly the midpoint of the array so that the potential difference between any two eQube measurements will not be overwhelming. The cable array may be laid out in a radial line away from the well of interest, in a direction that is consistent throughout the survey for each well tested. The cable, with closely spaced take-outs (5 and 10 m apart), is placed nearest the well, while the cable with the larger take-outs (20 or 40 m), is placed farther away. This helps to ensure a denser coverage close to the well, where the fields are likely to change the most rapidly with distance, and larger spacing farther away from the well, where the fields will be due to deeper parts of the well and thus changes in the fields will be broad. In general, the invention is only intended to be limited by the scope of the following claims.

1. A method for evaluating well casing integrity using electromagnetic measurements, the method comprising:
producing a current flow in a well casing using an electromagnetic source, wherein the well casing is located in a borehole;
measuring at least one component of an electromagnetic field emanating from the well casing based on sensor data received from at least one sensor located external to the borehole and either on the surface of the earth or beneath the surface of the earth at a depth of less than 5 meters;
determining at least one electromagnetic property of the well casing based on the at least one component of the electromagnetic field; and
determining an integrity of the well casing based on the at least one electromagnetic property of the well casing.

2. The method of claim 1, wherein the at least one electromagnetic property of the well casing is determined without being based on data from a sensor located in the borehole.

3. The method of claim 1, wherein the at least one electromagnetic property of the well casing comprises an electrical conductivity or magnetic permeability of the well casing.

4. The method of claim 1, wherein determining the integrity of the well casing includes determining if the well casing is corroded, broken or otherwise parted.

5. The method of claim 4, wherein determining the integrity of the well casing further includes determining a depth, a severity of a corrosion, a break or a parting.

6. The method of claim 1, wherein determining the integrity of the well casing includes determining if the well casing requires further evaluation or remediation.

7. The method of claim 1, wherein the at least one sensor measures an amplitude or phase of the electric potential or magnetic field.

8. The method of claim 1, wherein the sensor data is processed to improve signal quality by arithmetic averaging, filtering, calculating a coherence across multiple applied and measured signals or based on a lock-in technique.

9. The method of claim 1, wherein the sensor data is fit to a model comprising a background formation response and a well casing response, with each of the background formation and well casing response being based on empirical or theoretical data.

10. The method of claim 9, wherein the model constitutes a one-, two-, three- or four-dimensional representation of the well casing and a background formation in which the well casing is located.

11. The method of claim 1, wherein determining the integrity of the well casing includes monitoring the well casing during construction.

12. A system for evaluating well casing integrity using electromagnetic measurements, the system comprising:
an electromagnetic source configured to produce a current flow in a well casing located in a borehole;
at least one sensor, located external to the borehole and either on the surface of the earth or beneath the surface of the earth at a depth of less than 5 meters, configured to measure at least one component of an electromagnetic field emanating from the well casing; and
a controller configured to:
determine at least one electromagnetic property of the well casing based on the at least one component of the electromagnetic field; and
determine an integrity of the well casing based on the at least one electromagnetic property of the well casing.

13. The system of claim 12, wherein the controller is further configured to determine the at least one electromagnetic property of the well casing without relying on data from a sensor located in the borehole.

14. The system of claim 12, wherein the at least one electromagnetic property of the well casing comprises an electrical conductivity or magnetic permeability of the well casing.

15. The system of claim 12, wherein the controller is further configured to determine the integrity of the well casing by determining if the well casing is corroded, broken or otherwise parted.

16. The system of claim 15, wherein the controller is further configured to determine the integrity of the well casing by determining a depth a severity of a corrosion, break or a parting.

17. The system of claim 12, wherein the controller is further configured to determine the integrity of the well casing by determining if the well casing requires further evaluation or remediation.

18. The system of claim 12, wherein the electromagnetic source is configured so that the current flow produced in the well casing has a frequency between 0.05 Hz and 1 kHz or contains a sinusoidal, square, arbitrary or transient waveform.

19. The system of claim 12, wherein the electromagnetic source is in electrical contact with the well casing, the electromagnetic source comprises a drive point and a ground point connected to the earth, and the electromagnetic source is configured to apply an electrical signal between the drive point and the ground point to produce the current flow in the well casing, wherein the drive point is connected to the well casing at or above the surface of the earth, or the drive point is connected to the earth near the well casing.

20. The system of claim 12, wherein the electromagnetic source is configured to induce the current flow in the well casing through an inductive coupling to the well casing.

21. The system of claim 12, wherein the at least one sensor is configured to measure the electric potential of the earth or to measure the magnetic field of the earth.

22. The system of claim 12, wherein the at least one sensor comprises a first sensor configured to measure an electric potential of the earth and wherein the system further comprises a second sensor configured to measure a magnetic field of the earth.

23. The system of claim 12, wherein the at least one sensor is located on the surface of the earth, beneath the surface of the earth at a depth of less than 5 meters or more than 100 meters from a wellhead of the well casing.

24. The method of claim 1, wherein the electromagnetic source is located downhole and is electrical contact with the well casing downhole.

25. The method of claim 1, wherein the electromagnetic source is located on the surface of the earth and is in electrical contact with the well casing on the surface of the earth.
